(19) United States
(12) Patent Application Publication
(10) Pub. No.: US 2018/0354762 A1
(43) Pub. Date: Dec. 13, 2018

(54) MOBILE, PERSONAL LIFT WITH A TRANSLATABLE PLATFORM

(71) Applicant: Kenneth R Altizer, Mt. Nebo, WV (US)

(72) Inventor: Kenneth R Altizer, Mt. Nebo, WV (US)

(21) Appl. No.: 16/001,967

(22) Filed: Jun. 7, 2018

Related U.S. Application Data
(60) Provisional application No. 62/517,554, filed on Jun. 9, 2017.

(51) Int. Cl. B66F 11/04

(52) U.S. Cl. CPC B66F 11/04

(57) ABSTRACT

A personal lift having a mobile support, a translatable platform movably coupled with and relative to the mobile support, and a linear actuator affixed to the mobile support and coupled with the translatable platform. The mobile support includes a base, a plurality of vertical support bars, a plurality of horizontal cross bars, and a plurality of casters, and the translatable platform has a floor, a lower frame and an upper frame. The linear actuator, facilitates vertical movement of the translatable platform relative to the mobile support.

### BACKGROUND

The disclosed technology regards a mobile, personal lift with a translatable platform coupled with a mobile support.

At home, because of height, frailty, injury or disability, individuals may have difficulty reaching above them for items stored on a shelf, to change a light bulb, or otherwise. Presently, an individual may stand on a stool, chair or step stool in order to reach higher-up areas, potentially causing serious injury in the event the chair or stool tips over, or the individual loses his or her balance. Being unable to independently reach these areas can be frustrating or inconvenient. Therefore, there is a need for an affordable, mobile, powered, stable lift, for personal use.

### GENERAL DESCRIPTION

The mobile, personal lift of the disclosed technology provides an affordable, powered, stable lift, for personal use. The mobile, personal lift of the disclosed technology includes a translatable platform moveably coupled with a mobile support, having a linear actuator controlling vertical movement of the translatable platform relative to the mobile support.

The mobile support is defined by anterior, posterior, and a pair of opposing lateral sides, having a base, a plurality of vertical support bars, a plurality of horizontal cross bars, and a plurality of casters. The base is formed by a plurality of base bars, adjoined at their ends to form a pair of anterior corners and a pair of posterior corners.

Each of the plurality of vertical support bars of the mobile support is affixed to and extends vertically from an anterior or posterior corner of the rectangular base, wherein the vertical support bars at the anterior corners of the rectangular base have a length longer than the vertical support bars at the posterior corners of the rectangular base. The anterior vertical support bars each include a rail for engagement with a corresponding carriage of the translatable platform, as hereinafter described. The plurality of horizontal cross bars are affixed to and extend, respectively, between the tops of the anterior vertical support bars, and at an angle of inclination between the tops of the posterior and anterior vertical support bars on each lateral side of the mobile support. The mobile support further includes at least two casters supported on the anterior side of the mobile support.

The translatable platform of the mobile personal lift of the disclosed technology is movably coupled with and relative to the mobile support. Specifically, the translatable platform is defined by anterior, posterior and opposing lateral sides, with a floor, a lower frame and an upper frame. The lower frame of the translatable platform is formed from a plurality of platform support posts affixed to and extending vertically from each corner of the floor, with a plurality of coplanar platform cross posts extending between the support posts, in a plane parallel with the floor, and along the anterior and lateral sides of the translatable platform. A wedge extends along each of the lateral sides of the translatable platform, being affixed to the floor and positioned perpendicularly to the floor surface. Secured to each of the wedges is a carriage, positioned near the anterior side of the platform and in alignment with an anterior vertical support bar of the mobile support, for sliding engagement with the corresponding rail of the anterior vertical support bar.

The upper frame of the translatable platform includes an anterior side handrail and a pair of opposing lateral side handrails. The anterior side handrail, by means of vertical extension posts, extends upward from and adjoins the platform support posts of the anterior side of the translatable platform, forming an elevated handrail with a curvature at the adjoining point of the elevated handrail and the vertical extension posts. The lateral side handrails extend along the lateral sides of the translatable platform, from the vertical extension posts of the anterior side handrail to the corresponding support post of the posterior side of the translatable platform, with a curvature along at least a portion of the length thereof.

Controlling movement of the translatable platform relative to the mobile support is a linear actuator coupled with the anterior cross post of the translatable platform and the base of the mobile support structure; by such configuration, the linear actuator is able to vertically move the translatable platform relative to the mobile support. Operation of the linear actuator is controlled by, for example, a three position toggle switch, which may be affixed to the translatable platform, and is operably engaged with the linear actuator.

### DRAWINGS

Exemplary embodiments of the disclosed technology will become more fully understood from the detailed description provided below and the accompanying drawings, wherein like elements are represented by like reference numerals, which are given by way of illustration only and thus are not limiting and wherein:

FIG. 1 is a peripheral view of an embodiment of the disclosed technology;

FIG. 2 is another peripheral view of the embodiment of the disclosed technology shown in FIG. 1; and

FIG. 3 is another peripheral view of the embodiment of the disclosed technology shown in FIGS. 1 and 2.

FIG. 4 is another peripheral view of the embodiment of the disclosed technology shown in FIGS. 1-3, wherein the translatable platform is in an elevated position.

FIG. 5 is a rear view of an embodiment of the rail and carriage system of the personal lift of the disclosed technology, as installed on a mobile support and translatable platform of the embodiment of FIGS. 1-4.

FIG. 6 is a depiction of a suitable control mechanism of the disclosed technology, as affixed on the upper frame of the translatable platform of the embodiment of the disclosed technology shown in FIGS. 1-5.

### DETAILED DESCRIPTION

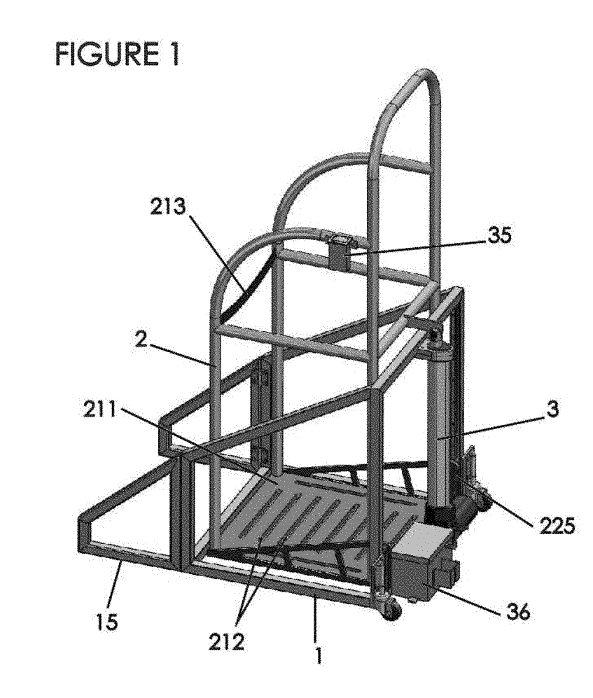

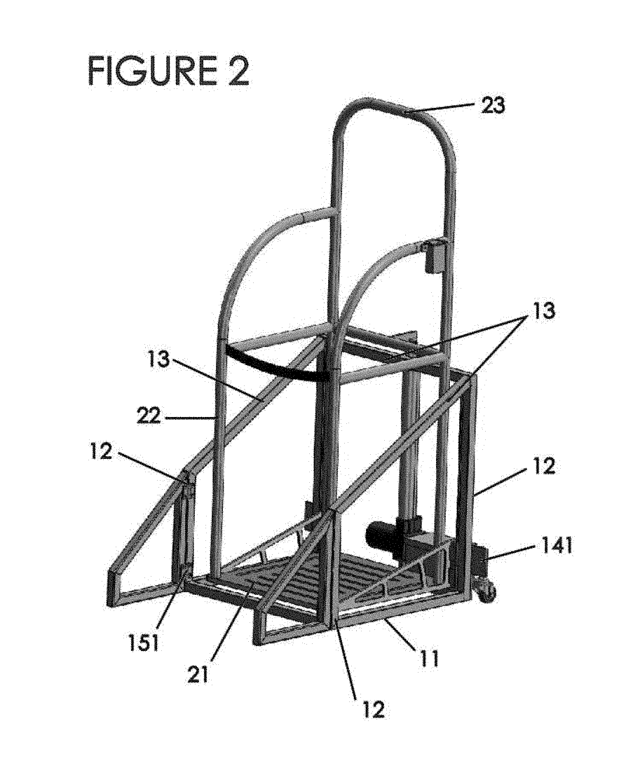

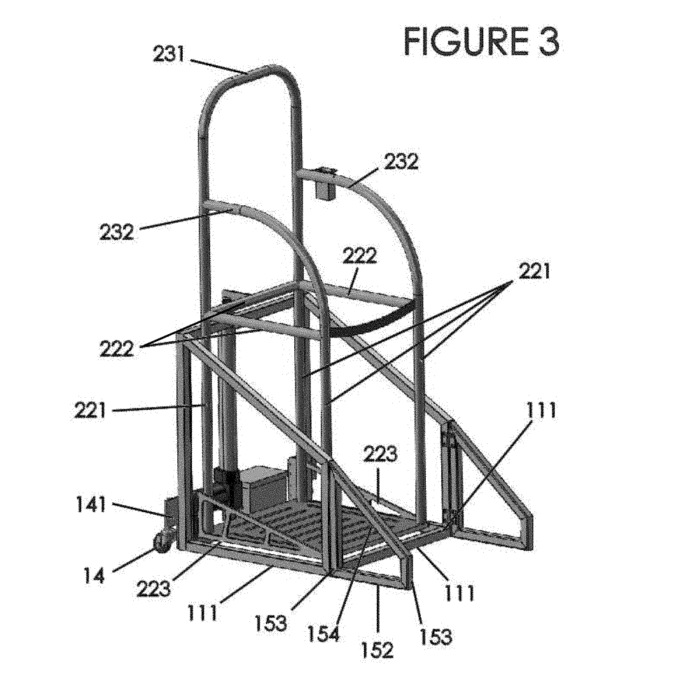

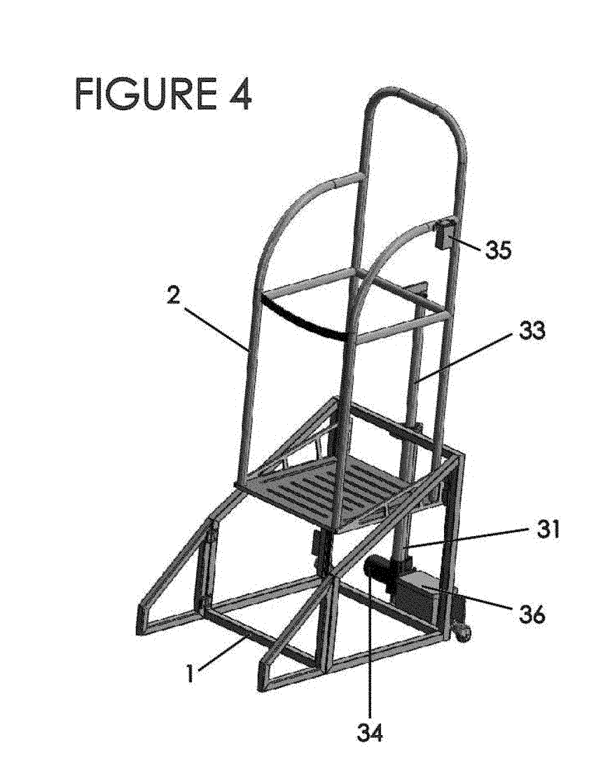

As shown in the embodiments of FIGS. 1-4, the mobile, personal lift of the disclosed technology includes a mobile support 1, a translatable platform 2 coupled with the mobile support, and a linear actuator 3 affixed to the mobile support and coupled with the translatable platform, controlling vertical movement of the translatable platform relative to the mobile support.

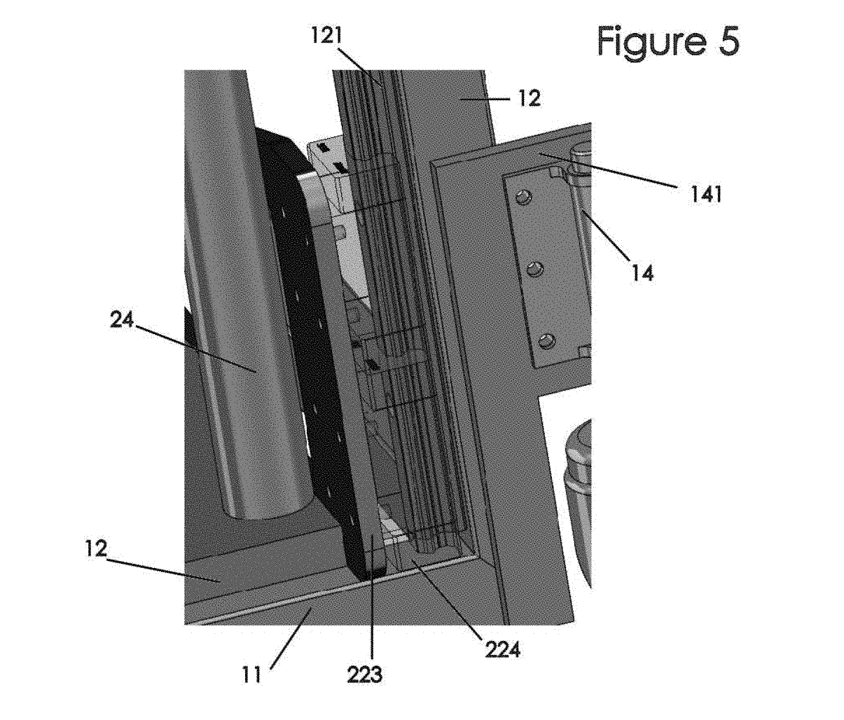

In the embodiments shown, the mobile support 1 is defined by anterior, posterior, and a pair of opposing lateral sides, having a rectangular base 11, a plurality of vertical support bars 12, a plurality of horizontal cross bars 13, and a plurality of casters 14. The rectangular base is formed by a plurality of base bars 111, adjoined at their ends to form a pair of anterior corners and a pair of posterior corners. In some embodiments the rectangular base has a height of between about 1″ and 1.5″, thereby limiting the range of movement necessary for a user to mount the translatable platform. Each of the plurality of vertical support bars 12 is affixed to and extends vertically from an anterior or posterior corner of the rectangular base, wherein the vertical support bars at the anterior corners of the rectangular base have a length longer than the vertical support bars at the posterior corners of the rectangular base. As shown in FIG. 5, each of the anterior vertical support bars includes a rail 121 for engagement with the corresponding carriage of the translatable platform, as hereinafter described. The rail 121 has a contour along the length thereof corresponding with the contour of the carriage so that the carriage is secured about and receives the rail, in sliding and secure engagement along the length thereof. Each of the plurality of horizontal cross bars 13 are affixed to and extend, respectively, between the tops of the anterior vertical support bars, and between the tops of the anterior and posterior vertical support bars on each lateral side of the mobile support, at an angle of inclination.

Further, in the embodiment shown the mobile support may further include a pair of trapezoidal support frames 15 for added stability of the personal lift of the disclosed technology. Each trapezoidal support frame may be hingedly affixed (by means of a plurality of hinges 151) to one of the posterior vertical support bars. In this embodiment, the trapezoidal support frames each have a frame base bar 152 coplanar with the base bars 111 of the rectangular base, a pair of frame vertical bars 153 affixed at each end of the frame base bar, and a frame cross bar 154 extending between the tops of the pair of frame vertical bars, at an angle of inclination from the posterior frame vertical bar to the anterior frame vertical bar. The angle of inclination of the frame cross bars may be greater than the angle of inclination of the horizontal cross bars, to economize space but provide sufficient stability to the mobile support. Due to the hinged connection of the trapezoidal support frames, when the personal lift is stored or not in use, the trapezoidal support frames may be repositioned to a position parallel with the posterior side of the mobile support.

The mobile support further includes at least two casters 14, as shown in the embodiment of FIGS. 1-5. The casters may be affixed to the mobile support by means of a plate 141, secured to the anterior side of the mobile support. In the embodiment shown, an L-shaped plate is secured to the anterior vertical support bars and to the anterior corners of the rectangular base to support the casters in a position adjacent the lateral and anterior sides of the mobile support.

As further shown in FIGS. 1-4, the translatable platform 2 of the mobile personal lift of the disclosed technology is movably coupled with and relative to the mobile support 1. The translatable platform of this embodiment is defined by anterior, posterior and opposing lateral sides, with a floor 21, a lower frame 22 and an upper frame 23. The floor 21 is defined by a plurality of corners at each adjoining point of the sides of the platform, and may have a surface 211 with a plurality of elongated apertures 212 formed therethrough. In an embodiment, the floor rests on top of the rectangular base, when in its lowest position. A removable safety belt 213 made of a flexible material may be removably provided across the rear of the platform to limit the potential of a fall from the translatable platform, when it is positioned above the base.

As shown in the embodiment of FIGS. 1-5, the lower frame 22 may have a plurality of platform support posts 221 and a plurality of coplanar platform cross posts 222, a pair of wedges 223, and a pair of carriages 224. In this embodiment the support posts 221 are affixed to and extend vertically from each corner of the floor. The coplanar platform cross posts 222 extend between the platform support posts, in a plane parallel with the floor, and along the anterior and lateral sides of the translatable platform. The wedges 223 are affixed to the floor along each of the lateral sides of the translatable platform, the wedges extending perpendicularly to the floor surface. The carriages 224 may be secured to the wedges by means of a plate 225, near the anterior side of the platform and in alignment with an anterior vertical support bar, the carriages being shaped and configured for sliding engagement with the contoured rail 121 of the anterior vertical support bar of the mobile support (see FIG. 5). To stabilize the translatable platform as it moves relative to the mobile support, the carriages may be configured to wrap around at least a portion of the sides of the contoured rail. Furthermore, the carriage length also contributes to the stability of the translatable platform. As shown in FIG. 5, the plate and the carriage may extend the depth of the floor.

In the embodiment shown, the upper frame 23 of the translatable platform includes uniquely designed support structures for stabilizing and providing hand grasps for physically challenged users. This embodiment may include an anterior side handrail 231 and a pair of opposing lateral side handrails 232, as shown in the Figures. The anterior side handrail 231, by means of vertical extension posts, extends upward from and adjoins the platform support posts of the anterior side of the translatable platform, forming an elevated handrail with a curvature at the adjoining point of the elevated handrail and the vertical extension posts. The lateral side handrails 232 extend along the lateral sides of the translatable platform, from the vertical extension posts of the anterior side handrail to the corresponding support post of the posterior side of the translatable platform, with a curvature along at least a portion of the length thereof.

The linear actuator 3 of the disclosed technology controls movement of the translatable platform relative to the mobile support, and may be an electro-mechanical, pneumatic, or hydraulic linear actuator. As shown in FIGS. 1-4, the linear actuator has a cylinder body 31 defining an internal bore, a piston slidably contained within the bore, and a piston rod 33 connected to the end of the piston. The piston moves within the internal bore of the cylinder body in response to fluid pressure from the external compressor 34, which movement translates into vertical movement of the piston rod 33. The piston returns to its original position by either a spring-back force or fluid being supplied to the other side of the piston. The cylinder body 31 of the linear actuator is coupled with the anterior cross post 222 and the base 11 of the mobile support structure, as shown in FIGS. 1-4; the piston rod 33 is coupled with the platform cross post 222 extending along the anterior side of the translatable platform, wherein vertical movement of the piston rod results in vertical movement of the platform cross post, and by its design and configuration results in vertical movement of the translatable platform relative to the mobile support.

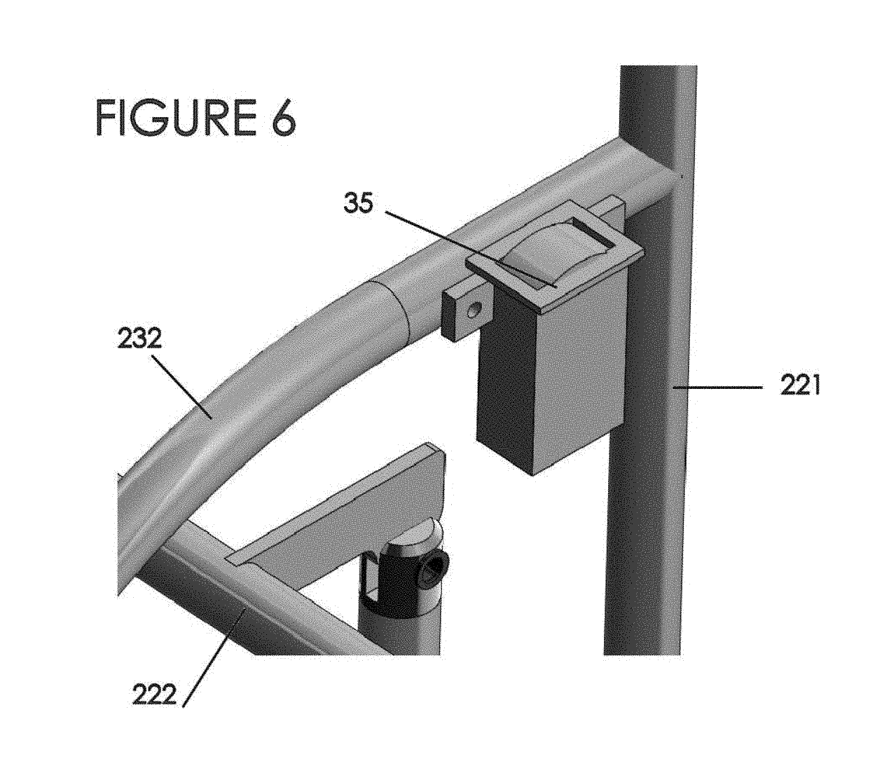

Operation of the linear actuator is controlled by a control mechanism 35 that is operably coupled with the linear actuator. The control mechanism may be positioned on, for example, a lateral side handrail 232 of the translatable platform (see FIG. 6); a three position toggle switch is an example of such a control mechanism, operably engaged with the linear actuator and affixed to the translatable platform.

For safety purposes, and as a means to steady the movement of the translatable platform relative to the mobile support, the linear actuator may be an electro-mechanical screw linear actuator, wherein rotary motion of a nut through which a screw is threaded results in vertical movement of the translatable platform (coupled with the screw) relative to the mobile support.

The compressor of the linear actuator 3 is powered by, for example, a battery stored within a battery housing 36, and electrically coupled with the linear actuator.

The foregoing descriptions of specific embodiments of the disclosed technology have been presented for purposes of illustration and description. They are not intended to be exhaustive, or to limit the claimed invention to the precise forms disclosed, and many modifications and variations are possible in light of the above teachings. The exemplary embodiments were chosen and described in order to best explain the principles of the disclosed technology and its practical application, to thereby enable others skilled in the art to best utilize the disclosed technology, and various embodiments with various modifications as are suited to the particular use are contemplated.

1. A personal lift comprising a mobile support, a translatable platform movably coupled with and relative to the mobile support, and a linear actuator affixed to the mobile support and coupled with the translatable platform, controlling vertical movement of the translatable platform relative to the mobile support:
wherein the mobile support is defined by anterior, posterior, and a pair of opposing lateral sides, having a base, a plurality of vertical support bars affixed to the base, a plurality of horizontal cross bars affixed among some of the vertical support bars along the anterior and opposing lateral sides of the mobile support, and a plurality of casters;
wherein at least some of the vertical support bars of the mobile support comprise a rail extending along at least a portion of the length of the vertical support bar;
wherein the translatable platform is defined by anterior, posterior and opposing lateral sides, the translatable platform comprising a floor, a lower frame affixed to the floor and an upper frame affixed to the lower frame;
wherein the lower frame comprises a plurality of platform support posts affixed to the floor, a plurality of coplanar platform cross posts secured between the platform support posts on the anterior and opposing lateral sides of the translatable platform, and a plurality of carriages;
wherein the carriages are secured to the lower frame in alignment with the vertical support bars of the mobile support comprising rails, the carriages being positioned and configured for sliding engagement with the rails of the vertical support bars;
wherein the linear actuator is coupled with a compressor, and comprises a cylinder body and a piston rod, and wherein the piston rod extends and moves vertically from and relative to the cylinder body; and
wherein the piston rod is coupled with the platform cross post extending along the anterior side of the translatable platform such that vertical movement of the piston rod results in vertical movement of the platform cross post, and resulting in vertical movement of the translatable platform relative to the mobile support.

2. The personal lift of claim 1,
wherein the base is formed from a plurality of base bars, adjoined at their ends to form a pair of anterior corners and a pair of posterior corners;
wherein each of the plurality of vertical support bars of the mobile support is affixed to and extends vertically from an anterior or posterior corner of the rectangular base;
wherein the vertical support bars comprising the rails extend vertically at the anterior corners of the base, and have a length longer than the vertical support bars extending vertically at the posterior corners of the base; and
wherein the horizontal cross bars on the lateral sides of the mobile support are affixed to the vertical support bars at an angle of inclination.

3. The personal lift of claim 1,
wherein the mobile support further comprises a pair of trapezoidal support frames;
wherein each trapezoidal support frame is hingedly affixed by means of a plurality of hinges to one of the vertical support bars affixed on the posterior side of the mobile support;
wherein each trapezoidal support frame has a frame base bar, a pair of frame vertical bars, each frame vertical bar being affixed at one end to opposing ends of the frame base bar, and affixed at a second end to opposing ends of a frame cross bar; and
wherein the frame vertical bars have varying lengths such that the frame cross bar is affixed to the second ends thereof at an angle of inclination.

4. The personal lift of claim 1, wherein each of the casters are affixed to the mobile support by means of a plate, the plates being secured to the vertical support bars on the anterior side of the mobile support to support the casters in a position adjacent both the lateral side and the anterior side of the mobile support.

5. The personal lift of claim 1, wherein the floor of the translatable platform comprises a surface having a plurality of elongated apertures, the floor being defined by a plurality of corners at each adjoining point of the anterior, posterior and opposing lateral sides of the platform, and wherein each of the supports posts are affixed to and extend vertically from the corners of the floor.

6. The personal lift of claim 1,
wherein the lower frame of the translatable platform further comprises a pair of wedges, the wedges being affixed to and extending perpendicularly from the floor along each of the lateral sides of the translatable platform; and
wherein each of the carriages is secured to one of the wedges of the lower frame.

7. The personal lift of claim 1,
wherein the upper frame extends vertically from the lower frame, and
wherein the upper frame comprises an anterior side handrail and a pair of opposing lateral side handrails.

8. The personal lift of claim 7, wherein the anterior side handrail extends from and adjoins the support posts of the anterior side of the translatable platform, with a curvature at each end of the anterior side handrail.

9. The personal lift of claim 7, wherein the lateral side handrails extend along the lateral sides of the translatable platform, from each of the support posts of the anterior side of the translatable platform to the corresponding support post of the posterior side of the translatable platform, with a curvature along at least a portion of the length thereof.

10. The personal lift of claim 1, wherein the cylinder body of the linear actuator is coupled with the anterior cross post and the base of the mobile support structure.

11. The personal lift of claim 1, further comprising a three position toggle switch affixed to the translatable platform, and operably engaged with the linear actuator.

12. The personal lift of claim 1, wherein the linear actuator is a pneumatic linear actuator.

13. The personal lift of claim 1, wherein the linear actuator is a hydraulic linear actuator.

14. The personal lift of claim 1, wherein the linear actuator is an electro-mechanical screw linear actuator.

15. The personal lift of claim 1, wherein the linear actuator further comprises a compressor in fluid communication with the cylinder body of the linear actuator.

16. The personal lift of claim 15, further comprising a battery to supply electricity to the compressor, and a battery housing secured to the base of the mobile support to store the battery.
